(19) United States
(12) Patent Application Publication
(10) Pub. No.: US 2026/0332546 A1
(43) Pub. Date: Oct. 22, 2026

(54) CUSTOMER CHAT BOT PROXY

(71) Applicant: 24[7].ai, Inc., Campbell, CA (US)

(72) Inventors: Jeetu Narayan, North York (CA); Pallipuram V. Kannan, San Martin, CA (US); Shanmugam Nagarajan, Austin, TX (US); Reginald Tang, Burlington (CA); Gary Sharples, Doreen (AU); Ashwin Kumar Rayaprolu, Whitby (CA)

(73) Assignee: 24[7].ai, Inc., Campbell, CA (US)

(21) Appl. No.: 19/183,758

(22) Filed: Apr. 18, 2025

(51) Int. Cl. H04L 51/02; G06F 40/30

(52) U.S. Cl. CPC H04L 51/02; G06F 40/30

(57) ABSTRACT

Proxying chat bot interactions includes the receipt of a customer service request in a chat bot message from a customer device and, in response to the customer service request, both submitting at least one prompt to a data structure of relevant queries for the customer service request and also receiving, in response to the at least one prompt, a selection of the relevant queries. Proxying chat bot interactions further includes relaying the selection of the relevant queries to a target chat bot in a sequence corresponding to return messages received from the target chat bot responsive to the queries. Finally, proxying chat bot interactions includes assembling text for a response to the customer service request incorporating selected portions of the return messages and transmitting a response message to the customer device encapsulating the assembled text.

### BACKGROUND OF THE INVENTION

### Field of the Invention

The present invention relates to the technical field of automated customer experience management in a chatbot.

### Description of the Related Art

The customer service request as a precursor to a customer service interaction between customer and customer service representative has long been part of the customer experience. Prior to the digitalization of customer service, the customer service request took the form of an in-person question to a customer service representative, or perhaps a telephonic conversation with a customer service representative, or some instances, a posted correspondence by mail to a customer service postal address. With the advent of Internet commerce, the customer service has transformed into a Web site form submission, or in more recent times, a live, interactive two-way conversation with a customer service representative within an online chat.

As to the latter, what began as a simple two-way exchange of questions and answers has morphed in some cases into a complex two-way exchange of questions and answers between a customer (a live human being) and a chat bot (a programmatic logic driven non-human digital conversationalist). The conventional chat bot has proven to be an effective tool in delivering low cost customer service inquiry response function to the satisfaction of a great many number of customers. However, the chat bot experience is not always well received by the customer. The most common frustration expressed by those interacting with a chat bot, is the necessity bourn by the programmatic driven nature of the chat bot and the inability of the chat bot to engage in spontaneous behavior of engaging in multiple exchanges in order to arrive at a resolution to a single customer service request. The customer simply prefers to submit a single customer service request and, as if the chat bot was a concierge, to receive a satisfactory response—a single exchange.

### BRIEF SUMMARY OF THE INVENTION

Embodiments of the present invention address technical deficiencies of the art in respect to chat bot interactivity. To that end, embodiments of the present invention provide for a novel and non-obvious method for proxying and personalizing customer experiences by adding advanced automation capabilities using artificial intelligence (AI) Models and Multi Agent Orchestration. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a method for proxying chat bot interactions includes the receipt of a customer service request in a chat bot message from a customer device from over a computer communications network. The method additionally includes, in response to the customer service request, submitting at least one prompt to a data structure of relevant dialog queries for the customer service request, which may include, for example, a large language model (LLM). Thereafter, the method includes receiving in response to the at least one prompt, a selection of the relevant queries. The method yet further includes relaying the selection of the relevant queries to a dialog interface to a target chat bot over the computer communications network in a sequence corresponding to return messages received from the target chat bot responsive to the queries. Finally, the method includes assembling text for a response to the customer service request incorporating selected portions of the return messages and transmitting over the computer communications network a response message to the customer device encapsulating the assembled text.

In one aspect of the embodiment, the prompt is a set of prompts which includes (A) an initial prompt as a textual transformation of the customer service request and (B) remaining prompts each including a textual transformation of a corresponding one of the return messages. To that end, the set of prompts can be generated from natural language generation, for instance by natural language processing the customer service request to identify an intent of the customer, then natural language processing the customer service request to identify relevant documents for the customer service request and then generating the prompts in the set of prompts using natural language generation incorporating the relevant documents and the intent. Of note, the set of natural language generated prompts, each are tuned to remove hallucinations and to insert contextual safety nets.

Finally, in even yet another aspect of the embodiment, the method may additionally include submitting the customer service request over the computer communications network to a sentiment analysis engine, so as to receive in response to the customer service request, a sentiment value from the sentiment analysis engine. As such, the method then includes incorporating the sentiment value as part of the initial query.

In another aspect of the embodiment, the method additionally includes applying a resolution rule to each of the return messages to determine whether or not the customer service request is resolved. Consequently, the method includes terminating the relaying upon a threshold determination by the resolution rule that the customer service request is resolved.

In yet another aspect of the embodiment, the method additionally includes identifying from the request, a target organization for the associated with the target chat bot and the querying of a table of pre-requisite information with at least a portion of the request and the identified target organization. Subsequently, the method includes receiving in response to the querying of the table of pre-requisite information, a list of information pre-requisite to answering the request. Finally, the method includes returning a message to the customer device incorporating the list of information.

In another embodiment of the invention, a data processing system is adapted for proxying chat bot interactions. The system includes a host computing platform of one or more computers or computing containers or virtual machines, each with memory and one or processing units including one or more processing cores. The system also includes network interface circuitry accessible by the processing units and communicatively coupled both to a customer device over a data communications network, and also a target chat bot over the data communications so that the host computing platform is intermediate to the customer device and the target chat bot. The system yet further includes a data structure of relevant queries associated with different customer service requests and accessible by the network interface circuitry. Finally, the system includes a chat bot proxy module.

The module includes computer program instructions which are enabled while executing by the at least one of the processing units of the host computing platform to receive a customer service request in a chat bot message from the customer device from over the data communications network, to submit at least one prompt to the data structure of relevant queries for the customer service request and to receive in response to the at least one prompt, a selection of the relevant queries. The program instructions additionally are enabled to relay the selection of the relevant queries to a dialog interface to the target chat bot over the data communications network in a sequence corresponding to return messages received from the target chat bot responsive to the queries. Finally, the program instructions are enabled to assemble responsive content such as text, audio or video, for a response to the customer service request incorporating selected portions of the return messages and to transmit over the data communications network a response message to the customer device encapsulating the assembled content.

In this way, the technical deficiencies of the burdening of the customer with repeated chat bot interactions to resolve a customer request of the customer are overcome owing to offloading of the iterative interactions to a proxy who receives only the primary request from the customer and through artificial intelligence, determines the necessary interactions to engage with a target chat bot in order to produce a final result for the benefit of the customer. Further, owing to the foregoing arrangements, the chat bot proxy is enabled as an option to bridge the interaction capabilities of the target vendor, such as language of interaction, device capability requirements of the customer, or device platform of the customer, with the limitations of the customer so that the chat bot proxy is enabled to incorporate language translation on behalf of the customer and the target vendor, or to bridge the device or device feature limitations of the customer to the device or feature requirements of the target chat bot of the target vendor.

As a further advantage, the chat bot proxy is enabled to proactively recommend additional tasks over and above the customer service request, even when the additional tasks are unrelated to the target vendor or outside the scope of the customer service request. To that end, the chat bot proxy can maintain an awareness of common follow-on requests typically accompanying the customer service request of a customer and provide a recommendation for the follow-on requests in response to the receipt of the initial customer service request from the customer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of proxying chat bot interactions;

FIG. 2 is a block diagram depicting a data processing system adapted to perform one of the aspects of the process of FIG. 1; and,

FIG. 3 is a flow chart illustrating one of the aspects of the process illustrated in FIG. 1.

### DETAILED DESCRIPTION OF THE INVENTION

Embodiments of the invention provide for proxying chat bot interactions. In accordance with an embodiment of the invention, chat box proxy receives a customer service request from a customer device and, in turn, composes a query to a data structure of relevant prompts for the customer service request. In response, the chat box proxy retrieves from the data structure a selection of the relevant prompts and sequentially relays individual ones of the relevant prompts in the selection to a target chat bot, each in correspondence to a return message received from the target chat bot responsive to a preceding one of the relayed prompts. Finally, the chat box proxy assembles text for a response to the customer service request which incorporates selected portions of the return messages of the target chat bot, and the chat bot proxy transmits a response message to the customer device which encapsulates the assembled text. In this way, the chat bot proxy acts as a customer impersonator to the target chat bot so as to effectively advocate on behalf of the customer without the target chat bot having an awareness that target chat bot is not directly interacting with the customer, but that the chat bot proxy acts on behalf of the customer.

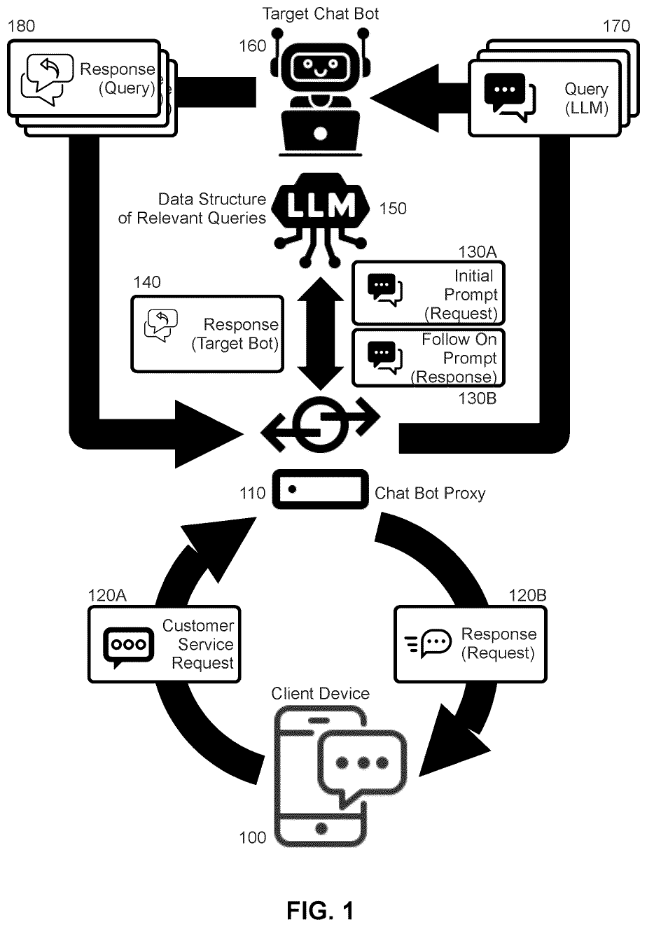

In illustration of one aspect of the embodiment, FIG. 1 pictorially shows a process of proxying chat bot interactions. As shown in FIG. 1, a client device 100 issues a customer service request 120A to a target vendor and the customer service request 120A is received in a customer chat bot proxy 110. The chat bot proxy 110 performs NLP upon the customer service request 120A in order to produce a textual representation of the customer service request 120A. The chat bot proxy 110 additionally can process the textual representation through a normalization process of tokenization and filtration of the textual representation in order to produce a uniform representation of the customer service request irrespective of the precise grammar and word choice reflected by the customer service request 120A. The chat bot proxy 110 then responds to the customer service request 120A by forming an initial prompt 130A to a data structure of relevant prompts 150 (such as an LLM). The initial prompt 130A includes the textual representation of the customer service request 120A such as a simplified equivalent statement and a characterization of the target vendor such as a vendor type, industry type of the target vendor, or a name of the target vendor.

The chat bot proxy 110 then submits the initial prompt 130A to the data structure of relevant queries 150 and receives in return from the data structure of relevant queries 150, response text 140. Optionally, the response text 140 can include an indication of a specific queue for a target vendor so that the customer service request 120A is services by a most efficient queue amongst a set of possible queues for the target vendor. Thereafter, the chat bot proxy 110 once again generates representative text from the response text 140 and incorporates the representative text in a dialog query 170 for transmission to a dialog user interface of a target chat bot 160 associated with the selected queue of the target vendor. In particular, the chat box proxy 110 submits the response text 140 to a natural language generation (NLG) engine in order to produce a natural language form of the response text 140 so as to appear as if the response text 140 had been directly presented by a human actor. The target chat bot 160 thereafter responds to the dialog query 170 with a target chat bot response 180 which is received in the chat bot proxy 110. The chat bot proxy 110 then generates representative text of the target chat bot response 180 and incorporates the representative text in a new prompt 130B for submission to the data structure of relevant queries 150.

Of import, the new prompt 130B can include a request for the data structure of relevant queries 150 to return an indication of an optimal query queue amongst several possible query queues for the target vendor. In particular, based upon the representative text of the target chat bot response 180, a different queue for the target vendor may be selected, such as for example, changing from a sales support queue to a technical support queue of the target vendor when the context of the representative text acts to indicate a necessity to change queues. In any case, as before, the data structure of relevant queries 150 returns response text 140 to the chat bot proxy 110. The chat bot proxy 110 then transforms the target chat bot response 180 into representative text in a new query 170 for submission to the target chat bot 160.

The target chat bot 160 thereafter responds to the new query 170 with a target chat bot response 180 which again is received in the chat bot proxy 110. The process repeats until such time as the chat bot proxy 110 determines that the responses 180 from target chat bot 160 are sufficient to answer the customer service request 120A, for instance by applying a termination rule to the responses 180 in reference to the customer service request 120A or by directing the data structure of relevant queries 150 to compare the customer service request 120A to the responses 180 and to conclude whether or not the customer service request 120A is sufficiently answered by the responses 180. At this juncture, the chat bot proxy 110 generates a request response 120B for transmission to the client device 100 as a response to the customer service request 120A.

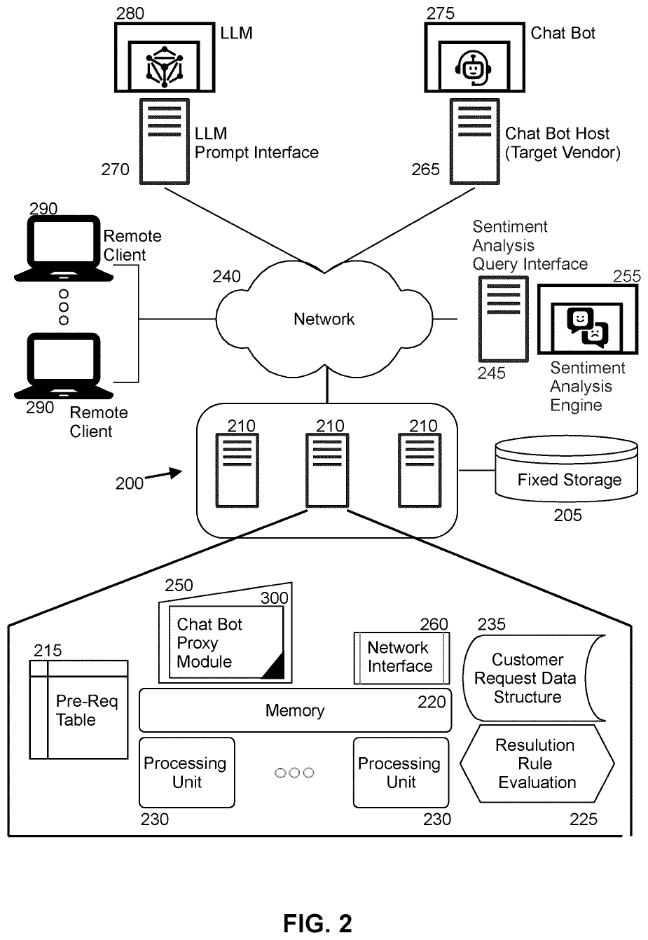

Aspects of the process described in connection with FIG. 1 can be implemented within a data processing system. In further illustration, FIG. 2 schematically shows a data processing system adapted to perform proxying chat bot interactions. In the data processing system illustrated in FIG. 1, a host computing platform 200 is provided. The host computing platform 200 includes one or more computers 210, each with memory 220 and one or more processing units 230 and fixed storage 205. The computers 210 of the host computing platform (only a single computer shown in detail for the purpose of illustrative simplicity) can be co-located within one another and in communication with one another over a local area network, or over a data communications bus, or the computers can be remotely disposed from one another and in communication with one another through network interface 260 over a data communications network 240.

Of note, the host computing platform 200 accesses an LLM prompt interface 270 to an LLM 280 over the data communications network 240 by way of the network interface 260. The LLM prompt interface 270 is adapted to receive prompts directing the LLM 280 to predict responsive text for supplied text. Through the LLM prompt interface 270, the network interface 260 can pass prompts to the LLM 280 and can receive from the LLM 280, responses to the prompts. The host computing platform 200 also accesses a sentiment analysis query interface 245 to a sentiment analysis engine 255. Through the sentiment analysis query interface 245, the network interface 260 can pass text to the sentiment analysis engine 255 and can receive from the sentiment analysis engine 255, responses to the text indicative of a sentiment expressed by the text. Of import, the sentiment can be used during NLG of queries for submission to the target chat bot so that the natural language of the queries reflects the sentiment of the customer.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for proxying chat bot interactions. Specifically, the program instructions during execution receive from a remote client 290 over the data communications network 240, a customer service request. The program instructions store the customer service request in a customer request data structure 235 in the memory 220 in which the program instructions associate the customer service request with a particular target vendor.

Optionally, the program instructions query the sentiment analysis query interface 245 with the customer service request in order to receive in response, a detected sentiment which the program instructions include in the customer request data structure 235. As an additional option, the program instructions perform a lookup against pre-requisite table 215 with the customer service request and the target vendor in order to receive, in return, a set of one or more pre-requisite data elements. To the extent that the pre-requisite table 215 returns a set of one or more pre-requisite data elements, the program instructions return a response to the remote client 290 with a prompt to provide the one or more pre-requisite data elements.

But, in either circumstance, the program instructions transform the customer service request into an initial prompt for submission to the LLM prompt interface 270 (including, potentially the sentiment) and the program instructions transmit the initial prompt over the data communications network 240 to the LLM query interface 270. The LLM prompt interface 270 responds with a response to the initial query (adapted, as an option, to the sentiment). Optionally, the response to the initial query can include a recommendation for a specific time of day when a target chat bot 275 is to be engaged on behalf of the customer in order to optimally provoke a response to the initial query.

Regardless, upon receiving the response to the initial prompt from the LLM prompt interface 270, the program instructions format a query with the response and transmit the query to a query dialog interface of a target chat bot 275 at chat bot host 265 over the data communications network 240. The target chat bot 275 responds to the host computing platform 200 with a response to the query. Upon receiving the response to the query, the program instructions invoke resolution rule evaluation 225 to determine if the response to the query is sufficient to resolve the customer service request. If so, the program instructions formulate a response to the customer service request with the response to the query and return the formulated response over the data communications network 240 to the remote client 290. But otherwise, the program instructions transform the response to the query into text for a follow on prompt to the LLM prompt interface 270 and the process repeats. In this way, the program instructions of the chat bot proxy module 300 iteratively interact with the target chat bot 275 on behalf of the remote client 290 without requiring tedious participation by the remote client 290 in order to arrive at a resolution to the customer service request.

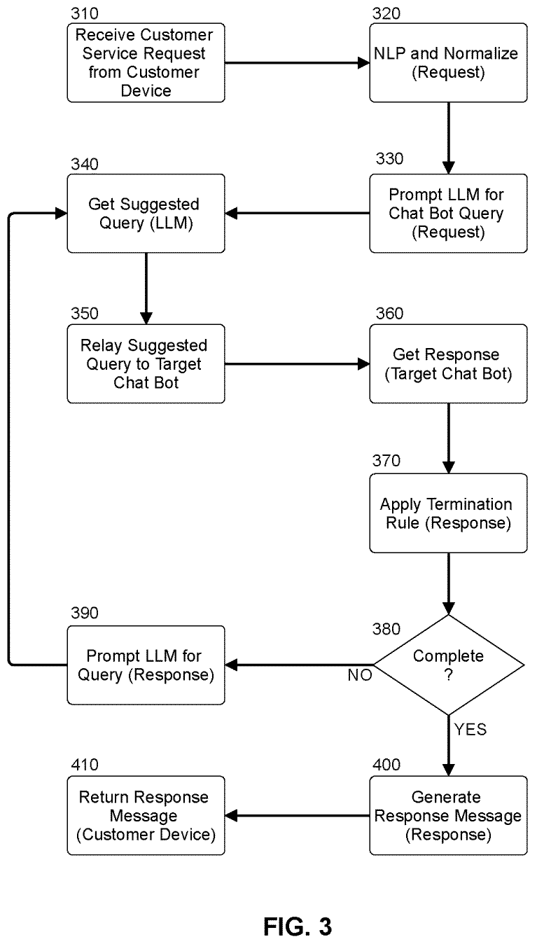

In further illustration of an exemplary operation of the module, FIG. 3 is a flow chart illustrating one of the aspects of the process of FIG. 1. Beginning in block 310, a customer service request is received in the chat bot proxy from a customer device and in block 320, the request is natural language processed (NLP) and then normalized to produce a uniform textual representation of the customer service request. In block 330, the data structure of relevant queries (in this example, an LLM) is prompted with the textual representation and in block 340, the data structure returns a suggested query. The suggested query can be a single block of query text to be transmitted to a dialog user interface of a designated target chat bot. Alternatively, the suggested query can be a set of two or more queries, each associated with a different target chat bot so that parallel processing of the customer service request can be performed by different target chat bots which in the aggregate, act to satisfy the customer service request. Thereafter, in block 350 the suggested query is relayed to the target chat bot or target chat bots as the case may be.

In block 360, a response to the query is received from the target chat bot and in block 370, a termination rule is applied to the response to the query in order to determine whether or not the customer service request has been adequately answered. In decision block 380, if it is determined that the response to the query does not adequately answer the customer service request, in block 390 a new prompt to the data structure is submitted with the response to the query as the basis and the process repeats in block 340 with the receipt of a newly suggested query from the data structure for relaying to the target chat bot. In decision block 380, on the other hand, if it is determined that the response to the query has been adequately answered, in block 400 a message is generated incorporating the response from the target chat bot and in block 410, the message is returned to the customer device.

As can be seen, the foregoing process is shown as a single thread of interaction between the chat bot proxy and the target chat box on behalf of the customer. But, in more advanced implementations, the process can be a multi-threaded set of interactions which in combination drive towards provoking a satisfactory response to the customer service request. In particular, the data structure in processing the initial query may determine that two or more different and separate interactions with different target chat bots (even at different target vendors) is required to resolve the customer service request. In that instance, the single threaded process shown in FIG. 3 can be launched for each one of the different and separate interactions.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for proxying chat bot interactions, the method comprising:
receiving a customer service request in a chat bot message from a customer device from over a computer communications network;
submitting at least one prompt to a data structure of relevant queries for the customer service request and receiving in response to the at least one prompt, a selection of the relevant queries;
relaying the selection of the relevant queries to a target chat bot over the computer communications network in a sequence corresponding to return messages received from the target chat bot responsive to the queries;
assembling text for a response to the customer service request incorporating selected portions of the return messages; and,
transmitting over the computer communications network a response message to the customer device encapsulating the assembled text.

2. The method of claim 1, wherein the data structure of relevant queries is a large language model (LLM).

3. The method of claim 1, wherein the at least one prompt is a set of prompts comprising an initial prompt as a textual transformation of the customer service request and remaining prompts each comprising a textual transformation of a corresponding one of the return messages.

4. The method of claim 3, further comprising submitting the customer service request over the computer communications network to a sentiment analysis engine, receive in response to the customer service request, a sentiment value from the sentiment analysis engine and incorporating the sentiment value as part of the initial prompt.

5. The method of claim 1, further comprising:
applying a resolution rule to each of the return messages to determine whether or not the customer service request is resolved; and,
terminating the relaying upon a threshold determination by the resolution rule that the customer service request is resolved.

6. The method of claim 1, further comprising:
identifying from the request, a target organization for the associated with the target chat bot;
querying a table of pre-requisite information with at least a portion of the request and the identified target organization;
receiving in response to the querying of the table of pre-requisite information, a list of information pre-requisite to answering the request; and,
returning a message to the customer device incorporating the list of information.

7. A data processing system adapted for proxying chat bot interactions, the system comprising:
a host computing platform comprising one or more computers, each with memory and one or processing units including one or more processing cores;
network interface circuitry accessible by the one or more processing units and communicatively coupled to a customer device over a data communications network, and also a target chat bot over the data communications so that the host computing platform is intermediate to the customer device and the target chat bot;
a data structure of relevant queries associated with different customer service requests and accessible by the network interface circuitry; and,
a chat bot proxy module comprising computer program instructions enabled while executing by the at least one of the processing units of the host computing platform to perform:
receiving a customer service request in a chat bot message from the customer device from over the data communications network;
submitting at least one prompt to the data structure of relevant queries for the customer service request and receiving in response to the at least one prompt, a selection of the relevant queries;
relaying the selection of the relevant queries to the target chat bot over the data communications network in a sequence corresponding to return messages received from the target chat bot responsive to the queries;
assembling text for a response to the customer service request incorporating selected portions of the return messages; and,
transmitting over the data communications network a response message to the customer device encapsulating the assembled text.

8. The system of claim 7, wherein the data structure of relevant queries is a large language model (LLM).

9. The system of claim 7, wherein the at least one prompt is a set of prompts comprising an initial prompt as a textual transformation of the customer service request and remaining prompts each comprising a textual transformation of a corresponding one of the return messages.

10. The system of claim 9, wherein the program instructions further submit the customer service request over the data communications network to a sentiment analysis engine, receive in response to the customer service request, a sentiment value from the sentiment analysis engine and incorporate the sentiment value as part of the initial prompt.

11. The system of claim 7, wherein the program instructions further:
apply a resolution rule to each of the return messages to determine whether or not the customer service request is resolved; and,
terminate the relaying upon a threshold determination by the resolution rule that the customer service request is resolved.

12. The system of claim 7, wherein the program instructions further:
identify from the request, a target organization for the associated with the target chat bot;
query a table of pre-requisite information with at least a portion of the request and the identified target organization;
receive in response to the querying of the table of pre-requisite information, a list of information pre-requisite to answering the request; and,
return a message to the customer device incorporating the list of information.

13. A computing device comprising a non-transitory computer readable storage medium having program instructions stored therein, the instructions being executable by at least one processing core of a processing unit to cause the processing unit to perform proxying chat bot interactions by:
receiving a customer service request in a chat bot message from a customer device from over a computer communications network;
submitting at least one prompt to a data structure of relevant queries for the customer service request and receiving in response to the at least one prompt, a selection of the relevant queries;
relaying the selection of the relevant queries to a target chat bot over the computer communications network in a sequence corresponding to return messages received from the target chat bot responsive to the queries;
assembling text for a response to the customer service request incorporating selected portions of the return messages; and,
transmitting over the computer communications network a response message to the customer device encapsulating the assembled text.

14. The device of claim 13, wherein the data structure of relevant queries is a large language model (LLM).

15. The device of claim 1, wherein the at least one prompt is a set of prompts comprising an initial prompt as a textual transformation of the customer service request and remaining prompts each comprising a textual transformation of a corresponding one of the return messages.

16. The device of claim 15, wherein the processing unit performs proxying chat bot interactions by further submitting the customer service request over the computer communications network to a sentiment analysis engine, receive in response to the customer service request, a sentiment value from the sentiment analysis engine and incorporating the sentiment value as part of the initial prompt.

17. The device of claim 13, wherein the processing unit performs proxying chat bot interactions by further:
applying a resolution rule to each of the return messages to determine whether or not the customer service request is resolved; and,
terminating the relaying upon a threshold determination by the resolution rule that the customer service request is resolved.

18. The device of claim 13, wherein the processing unit performs proxying chat bot interactions by further:
identifying from the request, a target organization for the associated with the target chat bot;
querying a table of pre-requisite information with at least a portion of the request and the identified target organization;
receiving in response to the querying of the table of pre-requisite information, a list of information pre-requisite to answering the request; and,
returning a message to the customer device incorporating the list of information.
